(19) United States
(12) Patent Application Publication
(10) Pub. No.: US 2026/0094595 A1
(43) Pub. Date: Apr. 2, 2026

(54) ASSEMBLY FORMING A SOUND-ABSORBING MATERIAL

(71) Applicant: Airbus Operations SAS, TOULOUSE (FR)

(72) Inventors: Arnulfo CARAZO MENDEZ, TOULOUSE (FR); Léana ROSSI, TOULOUSE (FR); Suresh PALANI, TOULOUSE (FR); Kevin BOUKHORS, TOULOUSE (FR); Maelle ALBERT, TOULOUSE (FR); Jonathan CAPRILE, TOULOUSE (FR)

(21) Appl. No.: 19/341,291

(22) Filed: Sep. 26, 2025

(30) Foreign Application Priority Data
Sep. 27, 2024 (FR) FR2410394

(51) Int. Cl. G10K 11/16

(52) U.S. Cl. CPC G10K 11/161

(57) ABSTRACT

An assembly forming a sound-absorbing material and having a sheet having at least two first zones pierced with holes and, for each first zone, a solid second zone, wherein the first and second zones are disposed alternating along a direction of alignment, and, for each first zone and associated second zone, a conduit having a first end which bears against the sheet around the first zone and a second end which bears against the sheet around the second zone.

### CROSS-REFERENCES TO RELATED APPLICATIONS

This application claims the benefit of French Patent Application Number FR2410394 filed on Sep. 27, 2024, the entire disclosure of which is incorporated herein by way of reference.

### FIELD OF THE INVENTION

The present invention relates to an assembly forming a sound-absorbing material, and to an arrangement based on said assembly.

### BACKGROUND OF THE INVENTION

During operation, an aircraft engine generates noise. This engine is accommodated in a nacelle and, in order to attenuate this noise, it is known practice to fit arrangements forming a sound-absorbing material around the engine in the structure of the nacelle.

Such arrangements forming a sound-absorbing material take the form for example of honeycomb structures. Such a honeycomb structure comprises two parallel sheets, one of which is perforated and between which hexagonal cells that are juxtaposed with one another are arranged.

Although, from an acoustic standpoint, such arrangements give good results, it is desirable to find an arrangement forming a sound-absorbing material that makes it possible to attenuate a wider range of acoustic frequencies.

### SUMMARY OF THE INVENTION

An object of the present invention is to propose an assembly forming a sound-absorbing material which can attenuate several acoustic frequencies, in particular both low and high frequencies.

To this end, what is proposed is an assembly forming a sound-absorbing material and comprising:
a sheet having at least two first zones pierced with holes and, for each first zone, a solid second zone, wherein the first and second zones are disposed alternating along a direction of alignment, and,
for each first zone and associated second zone, a conduit having a first end which bears against the sheet around the first zone and a second end which bears against the sheet around the second zone, said conduits being stacked one on another in a first stacking direction perpendicular to the direction of alignment.

Such an assembly makes it possible to obtain wide-band attenuation.

Advantageously, at least one conduit has, between its first end and its second end, a pierced intermediate wall disposed across said at least one conduit.

According to a particular embodiment, each conduit takes the form of a U and the conduits are nested one in another.

Advantageously, the assembly comprises two end walls and separating walls fixed in place between the end walls and forming the walls of the conduits.

According to a particular embodiment, conduits are delimited by two nested cones of revolution of which the bases bear against the wall and the conduits are nested one in another.

Advantageously, each first zone and each second zone take the form of a half-disc, the zones are offset by 180° from one conduit to the next, and, between the first and the second zone corresponding to one and the same conduit, said assembly comprises a separating wall which extends inside the conduit from the wall without reaching the vertex of the largest cone making up the conduit.

The invention also proposes an arrangement comprising an assembly according to one of the preceding variants, and wherein the arrangement comprises, at least at one second end, an exchange conduit intended to transport a heat-transfer fluid, wherein said exchange conduit passes along the corresponding second zone.

The invention also proposes an arrangement comprising two assemblies, according to a preceding variant, aligned end wall against end wall in a second stacking direction perpendicular to the direction of alignment, wherein each first zone of a first assembly is aligned with a first zone of the second assembly in the second stacking direction.

Advantageously, the arrangement comprises at least one exchange conduit intended to transport a heat-transfer fluid flowing through the assemblies at a second end of each of them and wherein said exchange conduit passes along the corresponding second zones.

The invention also proposes an arrangement comprising two assemblies, according to a preceding variant, aligned end wall against end wall in a second stacking direction perpendicular to the direction of alignment, wherein each first zone of a first assembly is aligned with a second zone of the second assembly in the second stacking direction.

The invention also proposes an arrangement comprising an assembly according to a preceding variant and a second arrangement forming a sound-absorbing material and comprising:
a sheet pierced with holes,
a honeycomb structure which has a plurality of cages, said honeycomb structure being next to the sheet,
and wherein the assembly and the second assembly are aligned in the first stacking direction perpendicular to the direction of alignment, such that the plurality of cages extends between the sheet of the second assembly and the sheet of the assembly.

Advantageously, each cage is aligned with the first end of a conduit and with the second end of a conduit.

### BRIEF DESCRIPTION OF THE DRAWINGS

The above-mentioned features of the invention, along with others, will become more clearly apparent upon reading the following description of an exemplary embodiment, said description being given with reference to the appended drawings, in which:

FIG. 1 is a sectional view of an arrangement using an assembly forming a sound-absorbing material according to a first embodiment of the invention,

FIG. 2 is a sectional view of an arrangement using an assembly forming a sound-absorbing material according to a variant of the first embodiment,

FIG. 3 is a perspective view of an arrangement according to a first embodiment variant of the invention,

FIG. 4 is a perspective view of an arrangement according to a second embodiment variant of the invention, and

FIG. 5 is a sectional view of an arrangement using an assembly forming a sound-absorbing material according to a second embodiment of the invention,

FIG. 6 is a sectional view of an arrangement using an assembly forming a sound-absorbing material according to a first embodiment of the invention, and

FIG. 7 is a sectional view of an arrangement using an assembly forming a sound-absorbing material according to a variant of the first embodiment of the invention.

### DETAILED DESCRIPTION OF THE PREFERRED EMBODIMENTS

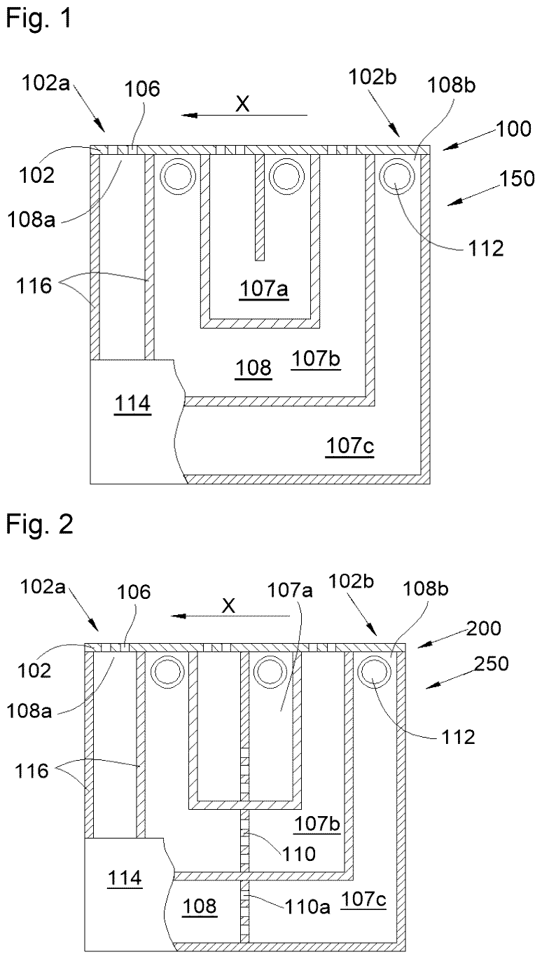

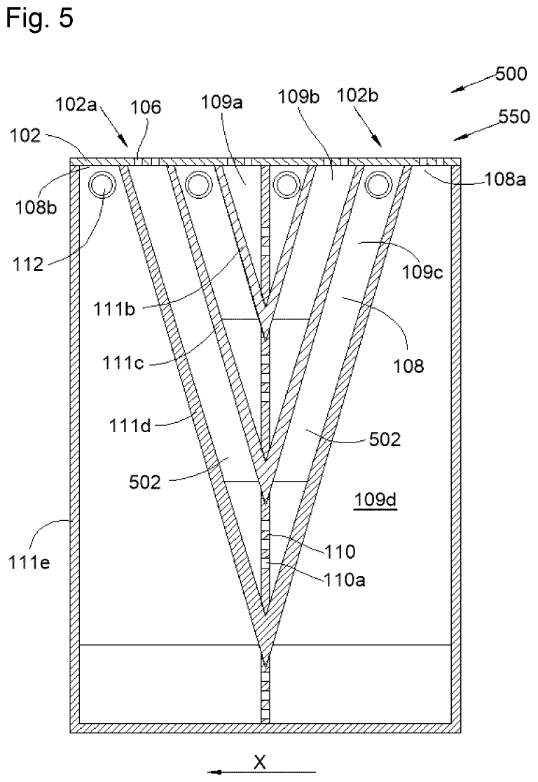

FIG. 1 shows an assembly 100 forming a sound-absorbing material according to a first embodiment of the invention and FIG. 5 shows an assembly 500 forming a sound-absorbing material according to a second embodiment of the invention. FIG. 2 shows an assembly 200 forming a sound-absorbing material according to a variant of the first embodiment.

FIGS. 1, 2 and 5 also show arrangements 150, 250 and 550 implementing the assemblies 100, 200 and 500.

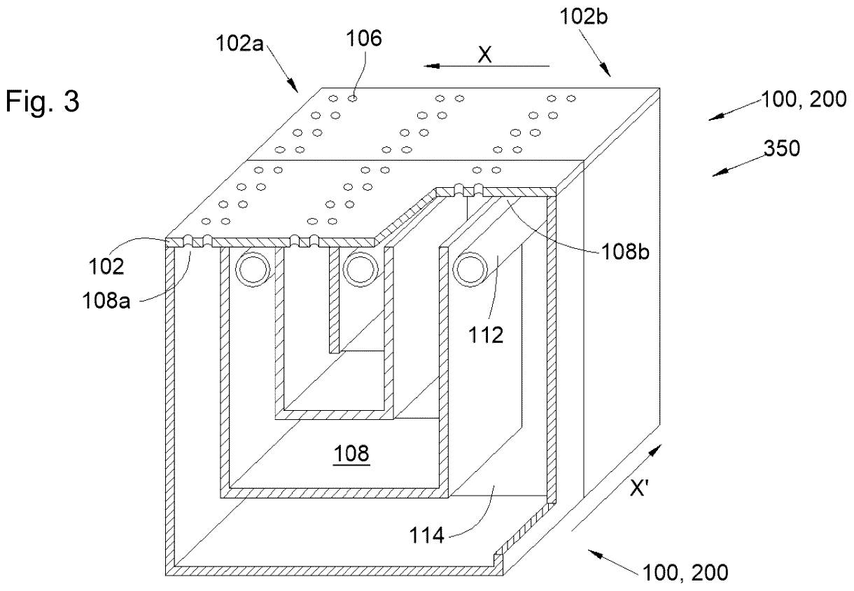

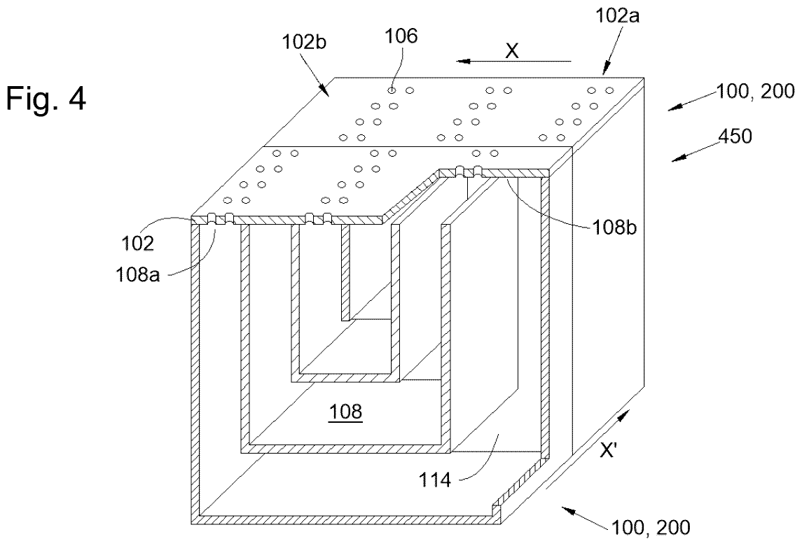

FIGS. 3 and 4 show other arrangements 350 and 450 implementing a combination of the assemblies 100, 200 according to the first embodiment.

The various elements making up the assemblies 100, 200 and 500 and the various arrangements 150, 250, 350, 450 and 550 can be made from various materials, for example metal materials such as aluminum or an alloy of aluminum, or composite materials. How the elements are fixed to one another will also depend on the materials used. Such assemblies 100, 200 and 500 and arrangements 150, 250, 350, 450 and 550 can be fitted for example in an aircraft engine to limit noise.

The assembly 100, 200, 500 comprises a sheet 102 which has at least two first zones 102a pierced with holes 106. These first zones 102a allow sound waves to pass through the sheet 102.

For each first zone 102a, the sheet 102 also has a second zone 102b which is solid, i.e., not pierced with holes, and the first and second zones 102a-b are disposed alternating along a direction of alignment X. Thus, a first zone 102a is located between two second zones 102b and vice versa, except at the edges of the sheet 102.

For each first zone 102a and associated second zone 102b, the assembly 100, 200, 500 has a conduit 108 which has a first end 108a and a second end 108b. The first end 108a bears against the sheet 102 around the first zone 102a, i.e., around the holes 106, and the second end 108b bears against the sheet 102 around the second zone 102b, i.e., this second end 108b is blind.

With preference, each end 108a-b is made to bear against the sheet 102 with acoustic tightness.

The conduits 108 thus constitute closed volumes and the waves that get in through the holes 106 will be attenuated as they travel through the conduits 108 and on arrival at the second end 108b.

The fitting of alternating zones with and without holes 106 allows better attenuation of the sound waves.

The conduits 108 can take various forms, for example they may be conduits constructed independently of one another.

In the first embodiment of the invention set out in FIGS. 1 and 2, each conduit 108 takes the form of a U and, generally speaking, the conduits 108 are nested one in another such that they form a stack in which all the ends of the vertical walls forming the U shapes come to bear against the sheet 102. In other words, in this case the conduits 108 are in the form of a U and, generally speaking, are stacked one on another in a first stacking direction Z.

In this case, three conduits referenced 107a-c are implemented. In this way, there is an inner conduit 107a, an intermediate conduit 107b between the walls of which the inner conduit 107a is arranged, and an outer conduit 107c between the walls of which the intermediate conduit 107b is arranged.

More specifically, each conduit 108 takes the form of a prism with a U-shaped base, which defines a conduit bottom.

The assembly 100, 200 thus comprises two end walls 114 and separating walls 116 which are fixed in place between the end walls 114 and are disposed such that they form the U-shaped walls of the conduits 108.

With preference, the two end walls 114 are mutually parallel and the separating walls 116 are flat, but a different arrangement is possible.

The assembly 100, 200 thus forms a rectangular overall block with solid and flat end walls 114.

By way of non-limiting example, the distance in the direction of alignment X between two separating walls 116 delimiting a conduit 108 ranges between 3 mm and 7 mm, and is for example equal to 4 mm or 5 mm. The thickness of a separating wall 116 is around 1 mm. The distance in the direction of alignment X between the two extreme separating walls 116 which both delimit an outer conduit 107c (width of the arrangement) ranges between 25 mm and 35 mm, and is for example equal to 30 mm. The distance in the second stacking direction X′ (better seen in the embodiment in FIG. 3) between two end walls 114 in FIG. 1 (length of the arrangement) ranges between 25 mm and 35 mm, and is for example equal to 30 mm. The distance between the sheet 102 and the bottom of the outer conduit 107c (height of the arrangement) ranges between 20 mm and 45 mm, and is for example equal to 24 mm or 40 mm.

With this overall U shape, each conduit 108 has three legs: two legs forming the lateral walls of the U and a leg forming the bottom of the U and connecting the lateral walls of the U to one another. The height of each lateral leg of the U of the outer conduit 107c ranges between 20 mm and 45 mm, and is for example equal to 24 mm or 40 mm. The height of each lateral leg of the U of the intermediate conduit 107b ranges between 15 mm and 40 mm, and is for example equal to 19 mm or 35 mm. The height of each lateral leg of the U of the inner conduit 107a ranges between 10 mm and 35 mm, and is for example equal to 14 mm or 30 mm. The effective length of the outer conduit 107c, between the first zone 102a and the second zone 102b, thus ranges between 80 mm and 120 mm, and is for example equal to 100 mm. The effective length of the intermediate conduit 107b, between the first zone 102a and the second zone 102b, thus ranges between 60 mm and 100 mm, and is for example equal to 80 mm. The effective length of the inner conduit 107a, between the first zone 102a and the second zone 102b, thus ranges for example between 30 mm and 70 mm, and is for example equal to 50 mm.

Each conduit 108 can thus attenuate sound waves around three resonant frequencies, one resonant frequency being attenuated by each leg of the U of the conduit 108, as a function of its length and its position. By way of non-limiting example, the outer conduit 107c in FIG. 1 can attenuate resonant frequencies of between 800 Hz and 900 Hz, for example around 850 Hz, between 1020 Hz and 1120 Hz, for example around 1070 Hz, and between 1660 Hz and 1760 Hz, for example around 1710 Hz. The intermediate conduit 107b in FIG. 1 can attenuate resonant frequencies of between 2520 Hz and 2620 Hz, for example around 2570 Hz, between 3160 Hz and 3260 Hz, for example around 3210 Hz, and between 5090 Hz and 5190 Hz, for example around 5140 Hz. The inner conduit 107a in FIG. 1 can attenuate resonant frequencies of between 4230 Hz and 4330 Hz, for example around 4280 Hz, between 5310 Hz and 5410 Hz, for example around 5360 Hz, and between 8520 Hz and 8620 Hz, for example around 8570 Hz.

In the second embodiment of the invention depicted in FIG. 5, four ducts referenced 109a-d are implemented. Each conduit 109a-d takes the form of a cone, the base of which bears against the sheet 102. Each conduit 109a-c thus takes the form of a V.

In this way, there is an inner conduit 109a, a first intermediate conduit 109b which is around the inner conduit 109a, a second intermediate conduit 109c which is around the first intermediate conduit 109b, and an outer conduit 109d which is around the second intermediate conduit 109c.

The inner conduit 109a is delimited by a first cone of revolution 111b and a dividing wall 111a which divides the inner volume of the first cone of revolution 111b into two sub-volumes from the sheet 102, one continuing the first end 108a and the other continuing the second end 108b.

The first intermediate conduit 109b is delimited between the first cone of revolution 111b and a second cone of revolution 111c larger than the first cone of revolution 111b, which is nested in the second cone of revolution 111c.

The second intermediate conduit 109c is delimited between the second cone of revolution 111c and a third cone of revolution 111d larger than the second cone of revolution 111c, which is nested in the third cone of revolution 111d.

The outer conduit 109d is delimited between the third cone of revolution 111d and a cylindrical vessel 111e around the third cone of revolution 111d. The vessel 111e extends as far as the sheet 102 and encloses the third cone of revolution 111d.

Aside from the inner conduit 109a and the outer conduit 109d, the other conduits 109b-c are delimited by two nested cones of revolution of which the bases bear against the sheet 102 and, generally speaking, the conduits 108 are nested one in another. In other words, the conduits 109a-d are delimited by cones, and have an overall V shape, and, generally speaking, are stacked one on another in the first stacking direction Z.

In the second embodiment of the invention and according to a particular embodiment, each first zone 102a and each second zone 102b take the form of a half-disc on the sheet 102.

The zones 102a-b are concentric with one another and thus the zones 102a-b are offset by 180° from one conduit 108 to the next. In other words, for a conduit, the first zone 102a is on a first side of a plane passing through the axis of the cones and the second zone 102b is on a second side of the plane. For the adjacent conduits 108, the reverse is true, i.e., the second zone 102b is on the first side of the plane and the first zone 102a is on the second side of the plane.

So that a sound wave does not pass directly from the first end 108a to the second end 108b, between the first and the second zone 102a-b corresponding to one and the same conduit 108, the assembly 500 comprises a separating wall 502 (visible in the background) which extends inside the conduit 108 from the sheet 102 and towards the vertex of the largest cone making up the conduit 108 but without reaching it, such that a passage is left for the wave.

FIG. 2 and FIG. 5 also show the possibility of fitting a septum in at least one conduit 108. That is to say, at least one conduit 108 has, between its first end 108a and its second end 108b, a pierced intermediate wall 110, also referred to as a “septum”, disposed across the conduit 108. Openings 110a thus pass through the intermediate wall 110.

FIGS. 1, 2 and 5 also show an arrangement 150, 250, 550 comprising an assembly 100, 200, 500 according to one of the variants set out above, wherein the arrangement 150, 250, 350 comprises, at least at one second end 108b, an exchange conduit 112 which transports a heat-transfer fluid. The exchange conduit 112 passes along the second zone 102b corresponding to the second end 108b.

The heat-transfer fluid is hot such that it allows heat energy to be transferred towards the second zone 102b of the sheet 102 to serve, for example, for de-icing the sheet 102 for example when it is at an air inlet of an aircraft engine.

In the embodiment of the invention set out in FIG. 1 and FIG. 2, the exchange conduits 112 pass through the end walls 114.

The arrangement 350 in FIG. 3 comprises two assemblies 100, 200 according to the first embodiment of the invention, and these two assemblies 100, 200 are aligned with the end wall 114 of an assembly 100, 200 against the end wall 114 of the other assembly 100, 200 in a second stacking direction X′ which is perpendicular to the direction of alignment X.

Each first zone 102a of a first assembly 100, 200 is aligned in the second stacking direction X′ with a first zone 102a of the second assembly 100, 200. In the same way, a second zone 102b of the first assembly 100, 200 is aligned in the second stacking direction X′ with a second zone 102b of the second assembly 100, 200.

The end walls 114 separate the two assemblies 100, 200.

If the arrangement 350 comprises an exchange conduit 112 which transports a heat-transfer fluid, the exchange conduit 112 passes through the assemblies 100, 200 at a second end 108b of each of them and the exchange conduit 112 passes along said second zones 102b which correspond to the second ends 108b and are aligned in the second stacking direction X′. An exchange of heat energy can then take place, as above.

By way of non-limiting example, the distance in the second stacking direction X′ between the end wall 114 of the assembly 100 and the end wall 114 of the assembly 200 ranges between 25 mm and 35 mm, and is for example equal to 30 mm. As a result, each assembly 100, 200 comprises conduits 108 with a length in the second stacking direction X′ two times less than those of the assembly in FIG. 1 or 2.

The arrangement 450 in FIG. 4 comprises two assemblies 100, 200 according to the first embodiment of the invention, and these two assemblies 100, 200 are aligned with the end wall 114 of an assembly 100, 200 against the end wall 114 of the other assembly 100, 200 in a second stacking direction X′ which is perpendicular to the direction of alignment X.

Each first zone 102a of a first assembly 100, 200 is aligned in the second stacking direction X′ with a second zone 102b of the second assembly 100, 200. In the same way, a second zone 102b of the first assembly 100, 200 is aligned in the second stacking direction X′ with a first zone 102a of the second assembly 100, 200. The end walls 114 separate the two assemblies 100, 200.

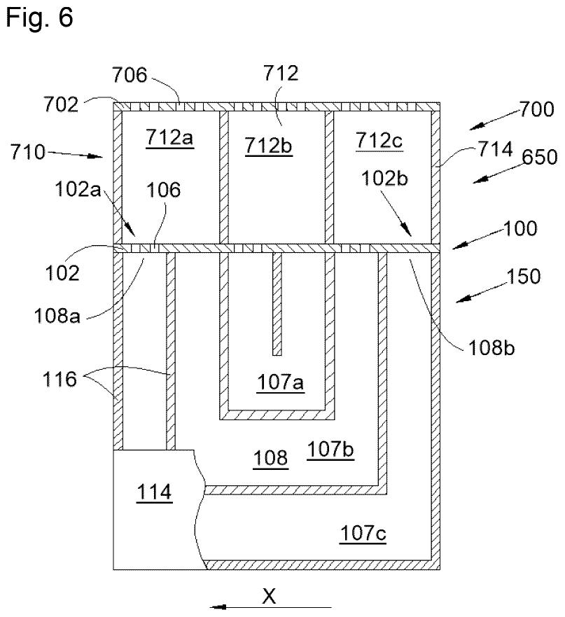

The arrangement 650 in FIG. 6 comprises an assembly 100 according to the first embodiment of the invention, and an assembly 700 forming a sound-absorbing material, these two assemblies 100, 700 being aligned in the first stacking direction Z which is perpendicular to the direction of alignment X and the second stacking direction X′. The first stacking direction Z extends along the height of the assembly 100. The first stacking direction Z, the direction of alignment X and the second stacking direction X′ are orthogonal in pairs.

The assembly 700 comprises a sheet 702 pierced with holes 706 which pass through it to allow the sound waves to pass. The assembly also comprises a honeycomb structure 710, next to the sheet 702, which comprises a plurality of cages 712, in this case three cages 712a-c, each of the latter being hollow and delimited by lateral walls 714. Each cage 712 delimits a hexagonal cell, but other shapes are conceivable. The cages 712 are in this case next to and in line with one another and each pair of neighboring cages 712 has a shared wall 714. Of course, it is also possible for the cages 712 to be disposed in a square. Of course, an assembly 700 may comprise more or fewer than three cages 712.

The assembly 700 is aligned in the first stacking direction Z with the assembly 100 by way of the sheet 102 of the assembly 100 which makes up a bottom wall of the cages 712. The cages 712 thus extend between the sheet 702 and the sheet 102. The assembly 700 is fixed to the assembly 100 by adhesive bonding, welding, etc. The holes 106 in the sheet 102 thus allow an acoustic connection between the assembly 700 and the assembly 100. The sound waves are firstly attenuated by the assembly 700, by passing through the holes 706 in the sheet 702 and the cages 712, before being attenuated by the assembly 100, by passing through the holes 106 in the sheet 102 and the conduits 108.

A cage 712 extends over a first zone 102a and over a second zone 102b of the sheet 102. The cages 712 are thus twice as wide (in the direction of alignment X) as the conduits 108. A first cage 712a is thus arranged above the first end 108a of the outer conduit 107c and above the second end 108b of the intermediate conduit 107b. A second cage 712a is thus arranged above the first and second ends 108a, 108b of the inner conduit 107a. A third cage 712c is thus arranged above the first end 108a of the intermediate conduit 107b and above the second end 108b of the outer conduit 107c. In other words, each cage 712 is aligned with the first end 108a of a conduit 108 and with the second end 108b of a conduit 108, and said first and second ends 108a, 108b can belong to the same conduit 108 or to different conduits 108.

By way of non-limiting example, the distance between the sheet 702 and the sheet 102 (height of the assembly 100 or height of the cages 712) in the first stacking direction Z ranges between 10 mm and 20 mm, and is for example equal to 15 mm.

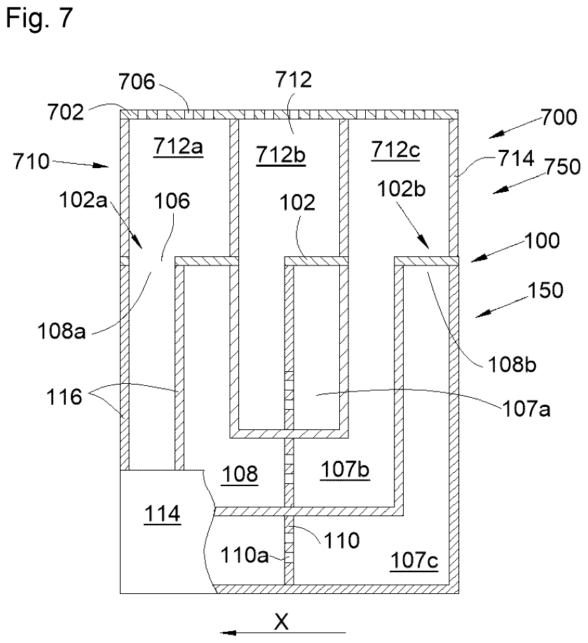

The arrangement 750 in FIG. 7 comprises an assembly 100 according to a variant of the first embodiment of the invention, and an assembly 700 according to the embodiment previously described. The assembly 100 comprises a sheet 102 which has first zones 102a pierced with a single hole 106 of the width (in the direction of alignment X) of the conduits 108. The sound waves are firstly attenuated by the assembly 700, by passing through the holes 706 in the sheet 702 and the cages 712, before being attenuated by the assembly 100, by meeting the conduits 108 and passing through the single hole 106 in the first zone 102a of the sheet 102.

Although the exchange conduits 112 are not depicted in embodiments in FIGS. 6 and 7, they may be present.

In the same way, although the pierced intermediate wall 110 is depicted solely in the embodiment in FIG. 7, it may be present in the embodiment in FIG. 6.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An assembly forming a sound-absorbing material, the assembly comprising:
a sheet having at least two first zones pierced with holes and, for each first zone, a solid second zone, wherein the at least two first zones and the solid second zones are disposed alternating along a direction of alignment, and
conduits, wherein for each of the at least two first zones and an associated second zone, a conduit having a first end bearing against the sheet proximate a first first zone of the at least two first zones and a second end which bears against the sheet around the associated second zone,
said conduits stacked one on another in a first stacking direction perpendicular to the direction of alignment.

2. The assembly according to claim 1, wherein at least one conduit has, between the first end and the second end, a pierced intermediate wall disposed across said at least one conduit.

3. The assembly according to claim 1, wherein each conduit comprises a U shape, and
wherein the conduits are nested one in another.

4. The assembly according to claim 3, further comprising:
two end walls; and
separating walls fixed in place between the two end walls and forming walls of the conduits.

5. The assembly according to claim 1, wherein the conduits are delimited by two nested cones of revolution having bases bearing against the sheet,
wherein the conduits are nested one in another.

6. The assembly according to claim 5, wherein the at least two first zones and the solid second zones each comprise a half-disc,
wherein the at least two first zones and the solid second zones are offset by 180° from one conduit to the next, and
wherein, between a first zone and a second zone corresponding to one of the conduits, said assembly comprises a separating wall extending inside the one of the conduits from the sheet without reaching a vertex of a larger cone making up the one of the conduits.

7. An arrangement comprising:
the assembly according to claim 1;
an exchange conduit at the second ends of the conduits and configured to transport a heat-transfer fluid,
wherein said exchange conduit passes along one of the solid second zones.

8. An arrangement comprising:
two assemblies according to claim 4, the two assemblies aligned end wall against end wall in a second stacking direction perpendicular to the direction of alignment,
wherein each first zone of the at least two first zones of a first assembly of the two assemblies are aligned with one first zone of the at least two first zones of a second assembly of the two assemblies in the second stacking direction.

9. The arrangement according to claim 8, further comprising:
at least one exchange conduit configured to transport a heat-transfer fluid flowing through the two assemblies at the second ends, and
wherein the at least one exchange conduit passes one of the solid second zones.

10. An arrangement comprising:
two assemblies according to claim 4, the two assemblies aligned end wall against end wall in a second stacking direction perpendicular to the direction of alignment,
wherein each first zone of the at least two first zones of a first assembly of the two assemblies is aligned with a second zone of a second assembly of the two assemblies in the second stacking direction.

11. An arrangement comprising:
an assembly according to claim 1; and
a second assembly forming a sound-absorbing material, the second assembly comprising:
a sheet pierced with holes,
a honeycomb structure which has a plurality of cages, said honeycomb structure being next to the sheet,
wherein the assembly and the second assembly are aligned in the first stacking direction perpendicular to the direction of alignment such that the plurality of cages extends between the sheet of the second assembly and the sheet of the assembly.

12. The arrangement according to claim 11, wherein each cage of the plurality of cages is aligned with the first end of one of the conduits and with the second end of one of the conduits.
